(19) United States
(12) Patent Application Publication
(10) Pub. No.: US 2003/0077422 A1
(43) Pub. Date: Apr. 24, 2003

(54) Build your own container

(76) Inventor: Diana Riddick, Tavernier, FL (US)

Correspondence Address: David W. Barman, 1101 NE 176 Terrace, North Miami Beach, FL, 33162, US

(21) Appl. No.: 10/278,262

(22) Filed: Oct. 23, 2002

Related U.S. Application Data
(60) Provisional application No. 60/330,513, filed on Oct. 23, 2001.

(51) Int. Cl. B32B 3/00

(52) U.S. Cl. 428/156

(57) ABSTRACT

An article for creating a container with user selected configuration, and a method for assembling a container are herein disclosed and described.

### CROSS REFERENCE TO RELATED APPLICATION

This application claims priority to US Provisional Application 60/330,513 filed on Oct. 23, 2001.

### SUMMARY OF THE INVENTION

This invention is for an article and method for forming custom sizes of storage containers. The user fabricates the article to allow easy sizing and assembly.

### BACKGROUND OF THE INVENTION

The need for storage containers and organizers at home in the workplace seems to be without end. As our lives get more complex, so do our needs in every aspect. Storage containers are not new. Containers used as desk organizers also have been used for many years. The limitation has always been the container size. People are often faced with the dilemma of containers not meeting a specific need. The containers that are commercially available may not be of the desired volume, or not of the desired dimensions. Certainly if one were have the option of configuring a container to a specific volume and dimension, it would serve a useful purpose to many types of users. The inventor encountered a problem in locating container of suitable dimensions to be placed on a desk with a personal computer. The inventor further envisioned containers suitable to be sized and used in kitchens, bedrooms, offices, and classrooms. The container often dictates the arrangement of a workspace. It was the idea of the inventor to create a container that is readily sized and assembled based on the needs of the user.

It is one object of an embodiment of the invention to provide an article that can be readily sized to construct a storage container.

It is another object of one embodiment of the invention to provide a single sheet that is scored to facilitate assembly into a-container.

It is another object of one embodiment of the invention to provide an article to be assembled without the use of tools.

It is another object of one embodiment of the invention to provide an article to be assembled without the use of scissors or knives.

It is another object of one embodiment of the invention to provide a method for assembling a container according to dimension and volume specification selected by the user.

### BRIEF DESCRIPTION OF THE DRAWINGS

FIG. 1 is an assembled container.

FIG. 2 is a sheet of material with vertical and horizontal scores.

FIG. 3 is a sheet of material with a section of material removed along vertical and horizontal scores.

FIG. 4 is a removed section from the scored material.

FIG. 5 shows the removal of sections to form the container.

FIG. 6 shows the folding of corners to assemble a container.

FIGS. 7-10 show the formation of the side pieces and various folds to form the container.

FIGS. 11-12 show embodiments to form covers for the containers.

FIG. 13 shows final assembly and securing with tape.

### DETAILED DESCRIPTION OF THE PREFERRED EMBODIMENT

1. The invention is directed to an article that can be assembled into a container. An article which can be assembled into a container comprising:

(a) single sheet of material, and

(b) scores on said sheet,

wherein said sheet with scores can be shaped into a usable container. The invention may be comprised of one or more sheets of a material suitable for forming a container. The container is readily sized at the time of use and encompasses configurations desired by the user. The configurations are length, width, height and volume. In one embodiment, the sheets are formed of paperboard 0.020 or larger. The paperboard is of sufficient thickness to form the sturdy sides, bottom, and optionally, the top of a container. While one embodiment envisions the use of paperboard, other suitable materials that may be scored and separated can also be used. The other materials may include, but are not limited to various plastics, polystyrenes, polypropylenes, wood, metal, metal composites, and the like. A suitable material is one that may be scored, readily separated, bendable and foldable so as to be formed and shaped into the container.

The term scored, as used herein, describes indentations in the surface of the sheet that are so formed as to allow for the bending and shaping of the sheet. The scores are not envisioned to facilitate immediate detachment of any section from the entire sheet. In a preferred embodiment, sections may be removed along score lines, without the use of tools. The term tools, refers to any implement used to contact the sheet. Tools may include, but would not be limited to, scissors, knives, or any cutting means. Repeated bending along a score line and applying gentle pressure away from the center of the sheet in order to cause separation would preform removal of any given section.

A container that may be assembled without tools would be particularly well suited for use by children or in a classroom setting.

In one embodiment the sheets may be formed into convenient sizes. These sheet sizes may include, but would not be limited to, 1′x1′, 1′x2′, 2′x2, 2′x3′ etc. The scoring is generally envisioned as square. Scores may be half inch, one inch, 2 inches or any desirable dimension so as to facilitate the sizing. Scoring may not be limited to squares, but in general is envisioned to run horizontal and vertical along the entire length of the sheet.

The invention also relates to a method in which a container of predetermined dimensions is formed through the steps comprising:

1. removing material from a scored sheet,

2. removing at least three corner squares from each corner, to form a tab;

3. fold each side to form wall of container, and

4. secure each created side with the tab created at each corner.

Material is removed from the sheet by repeatidly bending along a score line and applying gentle pressure in order to separate. The outermost edge of each corner requires the removal of at least three scored sections. When the corner sections are removed, a tab will be formed. This tab will be inserted between the outer and inner portions that are folded to form the walls of the container. It is envisioned that the method is accomplished without the use of tools.

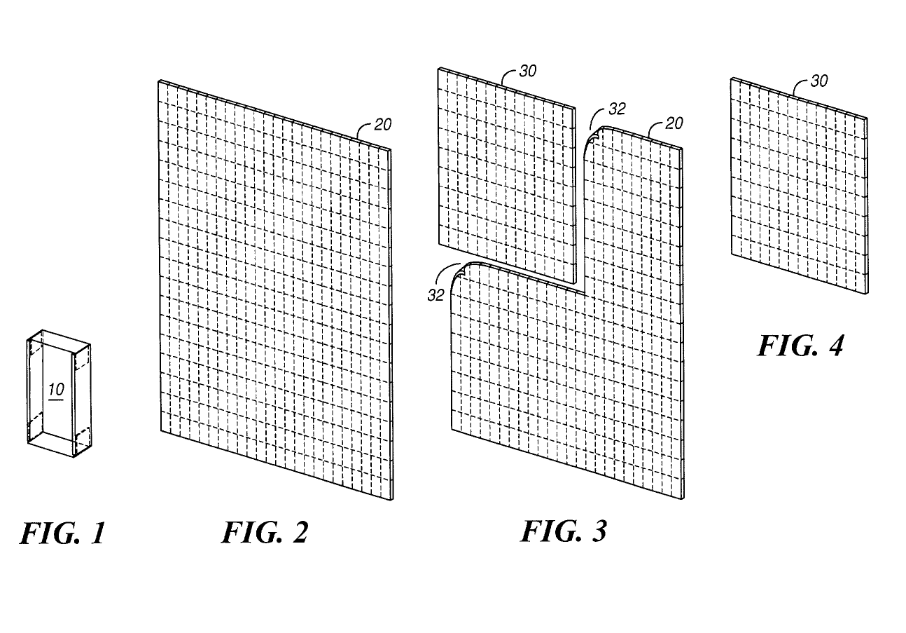

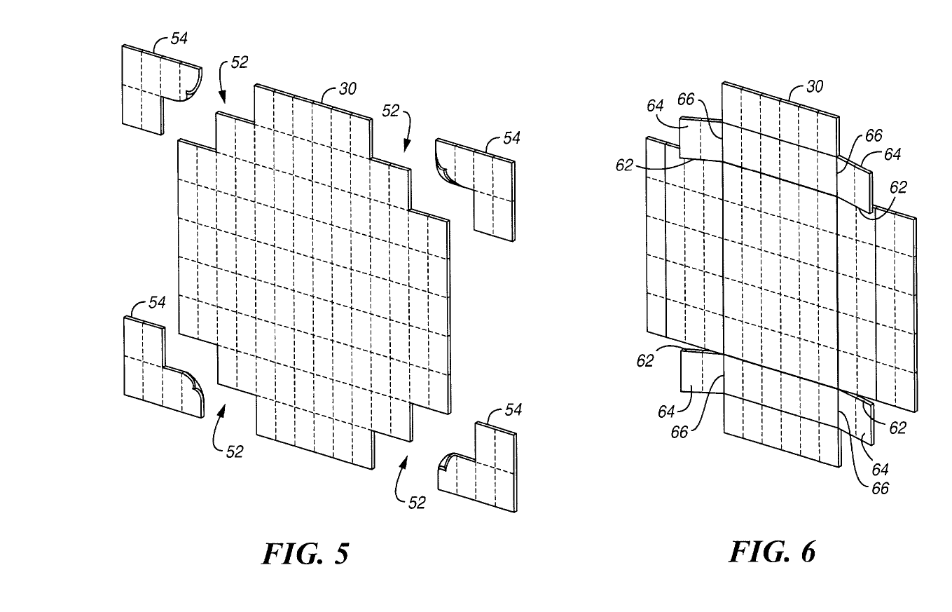

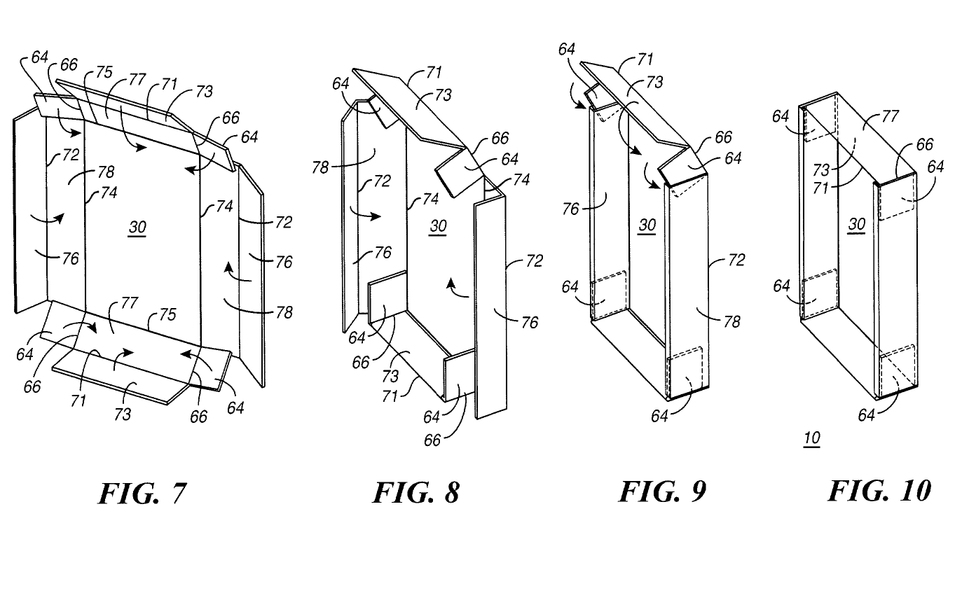

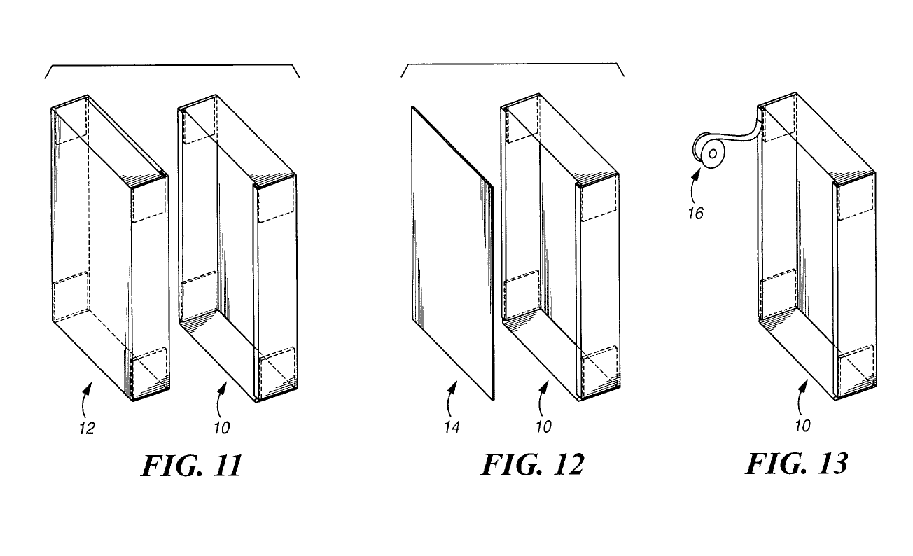

FIG. 1 is a container 10 that is formed by taking a starting sheet 20 shown in FIG. 2, and removing a section 30 shown in FIG. 3 from edges 32 of starting sheet 20. The completely detached section 30 in FIG. 4 then each corner of section 30 requires the removal of a corner section 54 as in FIG. 5, which will leave formation shape 52 on each corner of section 30. FIG. 6 shows a complete cut made along score 62 and a fold is made along score 66. The aforementioned cut and fold will create a flap 64 on each corner. FIG. 7 shows scored sheet 30 wherein centrally directed folds are made along scored portions 71, 72, 73, and 74. This will allow for each distal end, relative to the center to be folded and shaped to create the sides of the container. Sections 73 and 76 are folded towards the center and will create the inner edge of the sides. The inner sections will be adjacent such that 73 is adjacent to section 77 and 76 is adjacent to section 78. The previously created flaps 64 that are connected to combined sections 71 and 73 will be used as a tab. FIGS. 8 and 9 show the manner in which each section 64 flap will be place between the side pieces created by sections 76 and 78 when side pieces created by section 76 and 78 are folded centrally along fold 72. FIG. 10 shows the assembled container and the flaps 64 hidden from view in the assembled container between the formed inner and outer sides of sections 76 and 78. FIG. 11 depicts finished containers 10 and 12. FIG. 11 further depicts containers in which covers and lids of various configurations may be formed from the aforementioned starting sheet material 20. FIG. 13 depicts one embodiment, wherein said container may optionally be further secured and strengthened by applying a suitable closing material along the edge of the created side pieces. In this figure, the container is strengthened with tape. Any suitable adhesive such as tape, glue, contact cement, or mechanical means such as a paper clip, binder clip or clamp, may be used.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An article which can be assembled into a container comprising:
(a) single sheet of material; and
(b) scores on said sheet,
wherein said sheet with scores can be shaped into a usable container.

2. The article of claim 1 wherein said container has configurations selected by the user.

3. The article of claim 2 wherein said configurations are the length, width and height.

4. The article of claim 2 wherein said configurations is the volume.

5. The article of claim 1 wherein said single sheet is of sufficient thickness to provide for formation into a container.

6. The article of claim 1 wherein said single sheet is selected from materials consisting essentially of paperboard, plastics, polystyrenes, polypropylenes, wood, metal, and metal composites.

7. The article of claim 1 wherein said single sheet is paperboard.

8. The article of claim 1 wherein said single sheet is bendable and foldable.

9. The article of claim 1 wherein said single sheet wherein scored sections may be folded.

10. The article of claim 1 wherein said single sheet wherein said scored sections may be removed without the use of tools.

11. The article of claim 1 wherein said scores on said single sheet are horizontal and vertical.

12. The article of claim 1 wherein said scores on said single sheet are formed to create scored squares.

13. A method for assembling a container comprising the steps of:
(a) removing material from a scored sheet;
(b) removing at least three corner squares from each corner, to form a tab;
(c) folding each side to form wall of container; and
(d) secure each created side with the tab created.

14. The method of claim 13 wherein said removal of material is performed without tools.
